(19) United States
(12) Patent Application Publication
(10) Pub. No.: US 2004/0144163 A1
(43) Pub. Date: Jul. 29, 2004

(54) Storage tank leak detection system for petroleum products

(76) Inventors: Mark Lenard Kram, Santa Barbara, CA (US); Leroy Edward Laverman, Santa Barbara, CA (US)

Correspondence Address: GREENBERG TRAURIG LLP, 2450 COLORADO AVENUE, SUITE 400E, SANTA MONICA, CA, 90404, US

(21) Appl. No.: 10/702,250

(22) Filed: Nov. 4, 2003

Related U.S. Application Data
(60) Provisional application No. 60/424,527, filed on Nov. 6, 2002.

(51) Int. Cl. G01M 3/04

(52) U.S. Cl. 73/40.7

(57) ABSTRACT

A system for detecting leaks of petroleum based products in containers includes a sensor package comprising an LED and an optical photo-detector. The emitter transmits an excitation signal with an excitation wavelength, and the detector is tuned to the emission wavelengths of the petroleum based liquid in a space where detection is sought. An alarm system coupled to the detector may be used for notifying users in case of a leak.

### RELATED APPLICATIONS

This application is related to Provisional Application No. 60/424,527, filed on Nov. 6, 2002, the contents of which are incorporated by reference herein in their entirety.

### BACKGROUND OF THE INVENTION

1. Field of the Invention

The present invention relates generally to the use of optical sensors to detect the presence of petroleum based liquids in order to provide warning of leaks.

2. General Background and State of the Art

Underground storage tanks are used to store hazardous substances and petroleum products. If a leak occurs, these materials can enter the subsurface and contaminate ground water resources, requiring expensive assessment and remediation efforts. It is estimated that a significant proportion of the nearly five million tanks in the United States are leaking harmful products into the environment. To ameliorate this problem, the Environmental Protection Agency (the “EPA”) has recently promulgated regulations which require that any leakage exceeding a rate of 0.05 gallons per hour be detected and contained.

Methods for detecting leaks in storage tanks are well known in the prior art. Most of these techniques use a quantitative approach to identify a leak or to determine leak rate based on a measurement of volumetric changes of the stored product in the tank. The capability of prior art leak detection methods to accurately measure leakage is affected by certain variables such as temperature change, tank deformation, product evaporation, tank geometry and the characteristics of the stored product. The most significant of these factors is temperature variation, which causes dynamic expansion or contraction of the stored product on both a short-term and long-term basis. Indeed, changes in ambient temperature throughout the day are often large enough so as to “mask” the leakage rate to be measured. For example, a change of 0.01° F. per hour in a 10,000 gallon tank will cause a 0.068 gallon change in the product volume per hour, thus offsetting or amplifying an observed leak rate.

Most of the prior art methods for leak detection attempt to compensate for such temperature variations. Some prior art methods of leak detection for double walled storage tanks attempt to measure condensation in the interstitial space. There is still a need for a reliable and economical method and apparatus for storage tank leak detection system.

### SUMMARY OF THE INVENTION

While several interstitial tank release systems are currently in use, there are currently no optical systems based on fluorescence detection. The system according to the present invention is based on an extensive emission spectral library for petroleum-based compounds. Recent developments in light emitting diode (LED) and organic light emitting diode (OLED) technologies have led to the potential for inexpensive design alternatives. Currently available optical leak detection systems can only distinguish the difference between aqueous and non-aqueous media through the use of conductivity sensors. This increases the cost and complexity of the sensor and can lead to potential false positive alarms. The system according to the present invention is able to select the appropriate excitation and detection setup which can be optimized to match the fluorescence properties of stored petroleum materials using a spectral library. The system of the present invention also minimizes false alarms due to water condensation.

An object of the present invention is to provide an alarm trigger when petroleum based liquids (i.e., petroleum oils, lubricants, and oily wastes) stored in double-walled tanks have been released in the interstitial space. This device consists of a unique optical based sensor platform that detects a fluorescence signal from leaked petroleum products. The sensor can be coupled to an appropriate alarm system which notifies users of a release before it becomes an environmental hazard. Rough characterization of leaked petroleum liquids can be accomplished by using an array of sensors tuned to appropriate excitation and emission wavelengths. Excitation sources will be inexpensive light emitting diodes (LEDs) or organic light emitting diodes (OLEDs). The detection system consists of an appropriately filtered silicon photo-detector. The sensitivity can be dramatically increased by using a lock-in amplifier to reduce background noise.

Accordingly, in one aspect of the present invention, a system of detecting the presence of a petroleum based liquid comprises: (i) an excitation source for transmitting an excitation signal with an excitation wavelength, (ii) a detector tuned to the emission wavelengths of the petroleum based liquid in a space where detection is sought; and (iii) an alarm system coupled to the detector. The system may further include means for notifying when the detector detects a presence of said petroleum based liquid, a first band-pass filter for preventing a low energy scattered light signal to be delivered to the detector, and a second band-pass filter for removing the excitation signal. The excitation source includes at least one of a light emitting diode, an organic light emitting diode. The detector may be an optical sensor such as a silicon photo-detector. Additionally, the excitation and emission wavelengths may be determined from the fluorescence properties of the petroleum based liquid, wherein the fluorescence properties of the petroleum based liquid is determined from a spectral library.

Accordingly, in another aspect of the present invention, a method of detecting the presence of a petroleum based liquid comprises: (i) determining the appropriate excitation and emission wavelengths of said petroleum based liquid; (ii) locating a optical sensor tuned to the determined excitation and emission wavelengths in a space where detection is sought; (iii) coupling the sensor to an alarm system; and (iv) notifying a user when the optical sensor detects a possible release.

### BRIEF DESCRIPTION OF THE DRAWINGS

FIG. 1 is an exemplary depiction of the positioning of the petroleum detection sensor package in a tank;

FIG. 2 is a schematic of the sensor package including an optical sensor;

FIG. 3 is a plot of the transmission spectra of the excitation and emission filters according to one aspect of the present invention;

FIG. 4 is a circuit diagram including an operational amplifier for a 1:1 addition of two electrical signals;

FIG. 5 is an alternative embodiment for sensor placement in the interstitial space of a double wall storage tank positioned for facile installation and retrieval of a sensor head assembly.

### DETAILED DESCRIPTION OF THE INVENTION

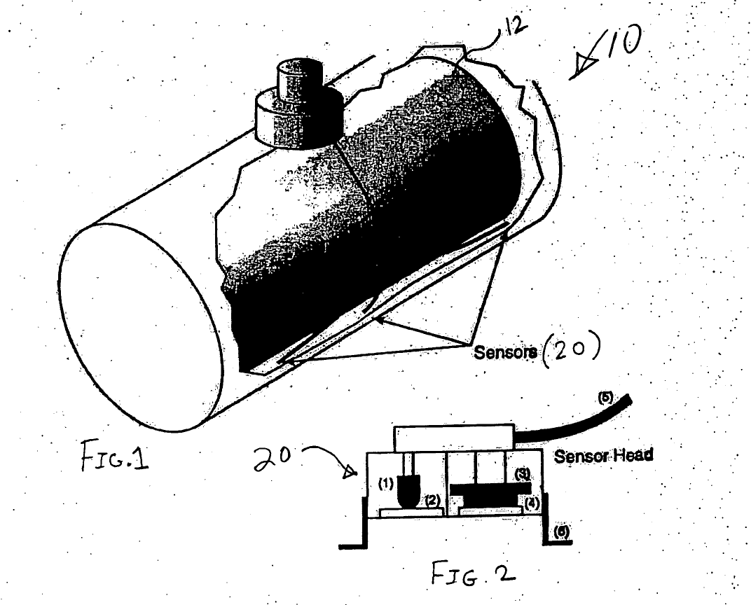

Reference will now be made in detail to an exemplary embodiment of the present invention, an example which is illustrated in the accompanying drawing (FIGS. 1-5).

Optimal detection parameters are determined for several selected petroleum materials commonly stored in underground and aboveground tanks (gasoline, fuel oils etc.) generally depicted as 12. Appropriate excitation and emission wavelengths are then selected for detecting specific petroleum based materials. The emission wavelengths generally vary depending on the petroleum product (in some cases these wavelengths are between 400 and 600 nm). In one aspect of the present invention, the excitation wavelengths may be in the ultra-violet region (e.g., 300-400 nm region) but may vary depending on the product to be detected. This information is used to determine off-the-shelf and customized devices for detecting petroleum liquid releases from the tank 12. The system of the present invention utilizes relatively inexpensive sensor and detection systems or package 20 configured to serve as a continuous real-time monitoring alarm system. This system will serve as a first alert warning prior to petroleum contaminant releases to the subsurface, protecting ground water resources on a global scale.

The system 20 is based on an extensive excitation-emission spectral library for petroleum-based compounds. Recent developments in light emitting diode (LED) and organic light emitting diode (OLED) technologies have led to the potential for inexpensive design alternatives. Currently available optical leak detection systems can only distinguish the difference between aqueous and non-aqueous media through the use of conductivity sensors. This increases the cost and complexity of the sensor and can lead to potential false positive alarms. The system according to the present invention is able to select the appropriate excitation and detection setup (e.g., the choice of LED excitation source and choice of bandpass filters as described below) which can be optimized to match the fluorescence properties of stored petroleum materials using a spectral library. The system also minimizes false alarms due to water condensation.

The spectral library refers to an extensive set of records of three dimensional excitation-emission spectra of many petroleum products. The three dimensional data allows one to choose the optical excitation and emission wavelengths for greatest sensitivity. In one aspect, this record may be in the form of a searchable library. While it is possible to use this library for optimizing the system (e.g., obtaining the greatest sensitivity), it may not always be necessary to do so, as the concentrations of fluorophores in the petroleum products can be so high that many excitation wavelengths may meet the sensitivity requirements for adequate detection. Thus, an option would be to “match”, or select an appropriate wavelength (either optimal or adequate for the intended use), by referring to the spectral library or by running a new analysis on the product of interest. This can be done by generating a guidance equation based on either the excitation wavelength optimization or the detection adequacy relative to (i) the detector used, and (ii) combined excitation and emission spectra. For instance, as long as the detection threshold is met using a specific wavelength, the system should work, and this will generally depend on the excitation device setup, the detector used, and the data processing approach.

The system 20 includes an optical sensor package including an appropriate emitter such as an LED or OLED 1 for detecting, through the use of the spectral library, the petroleum product of interest at the lowest detection level. The LED 1 can be linked to selected locations between the inner and outer wall of the double walled container 12 (e.g., low spots, areas of potential liquid accumulation following a release from the inner wall, etc.) by low voltage electrical cables 5. The detector is linked to an alarm or visible notification system (e.g., bright red light). Monitoring can be continuous or as frequently as deemed acceptable via a push button system, dial, or other mechanical or software device. If a breach is detected, the user can sample the space between the tank's two walls using existing technology for confirmation prior to tank excavation or leak repair.

The sensor head or package 20 is mounted via brackets 6, in one aspect of the invention, at the bottom of the interstitial space in a double wall storage tank 12. Leaking petroleum liquids will collect at the bottom of the tank and trigger an alarm from the detected fluorescence signal. The device depicted in FIG. 2 consists of two subassemblies, (1) excitation source 1 and an (2) optical detector 3 such as a photon detector. Excitation light will come from an ultra-violet or blue LED or OLED 1 chosen to match the petroleum product of interest. An appropriate band-pass filter 4 prevents lower energy scattered light from interfering with detection. A different band-pass filter (which may be coupled with the band-pass filter 4) removes the excitation light and allows only the fluorescence signal to be detected when fluorophores are present. In the absence of fluorophores no signal will be observed. Improved sensitivity can be achieved by modulating the excitation source and detecting the signal with a lock-in amplifier. This greatly improves the signal to noise ratio (SNR) and increases the sensitivity of the measurement. The signal may be delivered by the cable 5 for additional post-processing.

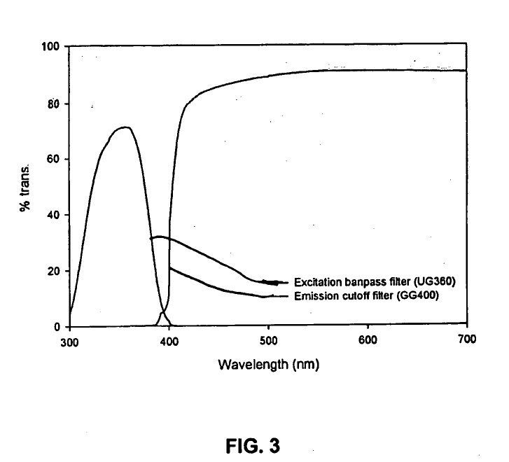

In one aspect of the invention, the choice of bandpass filters is determined by the choice of LED and detection region. In this scenario, the general idea is to prevent any light from the LED from striking the detector and giving a high background signal. Since, generally, LEDs are not monochromatic light sources, it is desirable to remove the long wavelength components with a bandpass or cutoff filler. This bandpass filter could be removed, provided the LED source has a sufficiently narrow wavelength range (i.e., a wavelength that does not overlap with the detection range). On the detection side, an additional filter is required to filter out the light from the excitation source. FIG. 3 shows the transmission curves for the two filters that could be used in the sensor. In the optimal situation, there will be virtually no overlap in the two curves thereby resulting in a very low signal in the absence of a leaked product.

There are several advantages of the present invention over prior art systems. The present invention provides for continuous real-time detection of petroleum tank release. The present invention similarly provides for continuous real-time notification of tank release. The system of the present invention is relatively inexpensive and can be readily adaptable to currently available double-walled tanks. The system is easily upgradeable after deployment to improve sensitivity. Furthermore, a major benefit of the present invention is that an optical system is not triggered by aqueous condensation, reducing the potential for false alarms.

Furthermore, excitation light source modulation and connection to a lock-in amplifier could be incorporated to increase system sensitivity and SNR, and hence may be included with the sensor package 20.

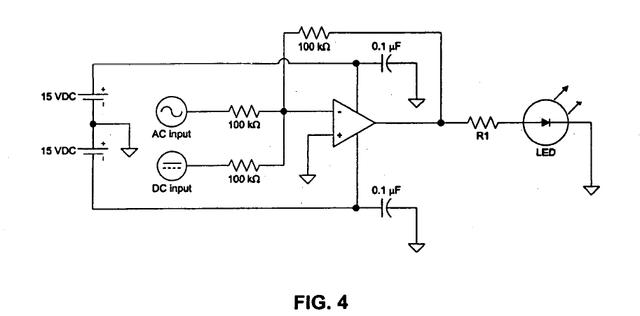

In one aspect of the present invention, the system may use AC and DC analog outputs from a lock-in amplifier (e.g., the Stanford Research Model SR510 lock-in amplifier). The two signals are added using a simple op-amp circuit (FIG. 4). The AC signal can be altered through a GPIB computer interface using software that could be written in LabView. In a real application of the sensor, according to the present invention, a much simpler circuit could be constructed to apply a square wave potential to the LED to apply an appropriate modulation frequency.

The advantages of modulating the excitation source and using lock-in amplification are a dramatic improvement in the signal to noise ratio. In one aspect of the present invention, the modulation frequencies may be of an order of about 200-400 Hz. Furthermore, lock-in amplification can result in several orders of magnitude in increased sensitivity. However, the system according to the present invention does not need to be overly sensitive, but needs to be only sensitive enough to detect the presence of a fuel product over some detection threshold. For many petroleum products, fluorophore concentrations in the mixtures are high enough to allow for detection at very low concentrations (e.g., detection is more of a presence/absence type of measurement).

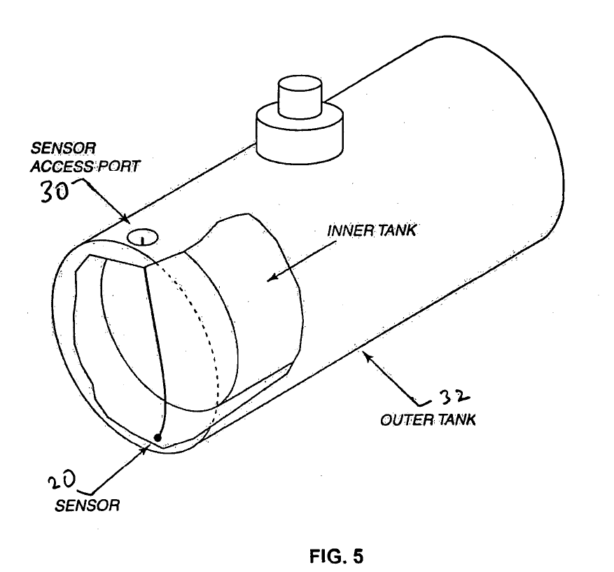

FIG. 5 is an alternative embodiment for sensor placement in the interstitial space of a double wall storage tank. The sensor access port 30 allows for retrieval and replacement of the sensor if required. The sensor is placed in a location where released product can accumulate in the outer tank 32 (e.g., a low elevation position or an engineered depression.

In another aspect of the present invention, the sensor system could be constructed by simply monitoring the voltage from the photodiode using a continuously on diode. If the fluorescence signals are sufficiently intense, then this would end in a system that is fairly cheap and simple.

In an alternative embodiment, instead of LED's, the following detectors may be used: (i) Photomultiplier tubes (PMTs), (ii) Avalanche photodiodes (APDs), (iii) Diode array detectors, (iv) Charge coupled devices (CCDs), or (v) CMOS sensors.

Furthermore, other excitation sources, that provide much greater power than LEDs or OLEDs, could be included in the sensor package. These include: (i) Arc lamps (Xe, Hg), (ii) Deuterium lamps, (iii) Gas lasers (e.g., nitrogen lasers, excimer lasers (XeF, XeCl)), (iv) Solid state lasers (e.g., frequency tripled Nd:YAG).

Additionally, alternate delivery mediums such as optical fibers, fiber bundles or liquid filled light guides may be placed in the interstitial space of the storage tank. For example, one set of fibers for delivering the excitation source and an additional set of fibers for recovering the emitted fluorescence signal may be used. With appropriate optics, single fibers may be used for both excitation and emission signals. This has the advantage of removing all electrical components from inside the tank and placing them remotely.

It is to be understood that other embodiments may be utilized and structural and functional changes may be made without departing from the respective scope of the present invention. Possible modifications to the system include, but are not limited to, generation of a stand-alone software package, linking the system to an automatic measurement device set for a specific time step, linking the system to an alarm which could be audible, or contacting the responsible parties via telephone or electronic mail. Multiple sensors can be used to monitor large-scale tank farms with control via appropriate software. In addition, the sensors can be strategically placed in the interstitial walls of an oil tanker and marine fuel tanks.

We claim:

1. A method of detecting the presence of a petroleum based liquid, the method comprising the steps of:
determining the appropriate excitation and emission wavelengths of said petroleum based liquid;
locating an optical sensor tuned to the excitation and emission wavelengths in a space where detection is sought;
coupling the sensor to an alarm system; and
notifying a user when the optical sensor detects a possible release.

2. The method of claim 1 wherein the optical sensor is a light emitting diode.

3. The method of claim 1 wherein the optical sensor is an organic light emitting diode.

4. The method of claim 1 wherein the optical sensor is a silicon photo-detector.

5. The method of claim 1 wherein the excitation and emission wavelengths are determined from the fluorescence properties of the petroleum based liquid.

6. The method of claim 1 wherein the fluorescence properties of the petroleum based liquid is determined from a spectral library.

7. A system of detecting the presence of a petroleum based liquid, the system comprising:
an excitation source for transmitting an excitation signal with an excitation wavelength;
a detector tuned to the emission wavelengths of said petroleum based liquid in a space where detection is sought; and
an alarm system coupled to the detector.

8. The system of claim 7 wherein the excitation source includes a light emitting diode.

9. The system of claim 7 wherein the excitation source includes an organic light emitting diode.

10. The system of claim 7 wherein the detector is an optical sensor.

11. The system of claim 10 wherein the optical sensor includes a silicon photo-detector.

12. The system of claim 7 wherein the excitation and emission wavelengths are determined from the fluorescence properties of the petroleum based liquid.

13. The system of claim 7 wherein the fluorescence properties of the petroleum based liquid is determined from a spectral library.

14. The system of claim 7 further including means for notifying when the detector detects a presence of said petroleum based liquid.

15. The system of claim 7 further including a first band-pass filter for preventing a low energy scattered light signal to be delivered to the detector.

16. The system of claim 7 further including a second band-pass filter for removing the excitation signal.

17. A method of detecting the presence of a petroleum based liquid, the method comprising the steps of:
determining an excitation wavelength and emission wavelength of said petroleum based liquid;
transmitting an excitation signal from an emitter;
detecting the emission wavelength of the petroleum based liquid using a photo-detector, wherein the photo-detector is tuned to the emission wavelength of said petroleum based liquid, coupling the photo-detector to an alarm system; and
notifying a user when the photo-detector detects a presence of said petroleum based liquid.

18. The method of claim 17 wherein the emitter includes a light emitting diode.

19. The method of claim 17 wherein the emitter includes an organic light emitting diode.

20. The method of claim 17 wherein the excitation and emission wavelengths are determined from the fluorescence properties of the petroleum based liquid.

21. The method of claim 17 wherein the fluorescence properties of the petroleum based liquid is determined from a spectral library.

22. The method of claim 17 further including the step of band-pass filtering for preventing a low energy scattered light signal to be delivered to the detector.

23. The method of claim 17 further including the step of band-pass filtering for removing the excitation signal.

24. The method of claim 17 further including the step of modulating the excitation signal for increasing the sensitivity during the detection step.
